(19) United States
(12) Patent Application Publication
(10) Pub. No.: US 2024/0206429 A1
(43) Pub. Date: Jun. 27, 2024

(54) Pet Watering Device

(71) Applicants: Timothy Miller, Tipton, IN (US); Diane Miller, Tipton, IN (US)

(72) Inventors: Timothy Miller, Tipton, IN (US); Diane Miller, Tipton, IN (US)

(21) Appl. No.: 18/581,882

(22) Filed: Feb. 20, 2024

Related U.S. Application Data
(60) Provisional application No. 63/434,735, filed on Dec. 22, 2022.

(51) Int. Cl. A01K 7/02

(52) U.S. Cl. CPC A01K 7/025

(57) ABSTRACT

A pet watering device incudes a base that has a pet drinking portion and a water reservoir portion connected with a leveling channel. A valve activation projection extends upwardly from water reservoir portion aligns with a valve button. A water container fits above and rest upon the water reservoir portion and has a reduced-size neck. A cap removably seals the neck and encloses a valve that controls a passageway between the water container and a lower opening in the cap. The valve is activated by a button bearing against the valve activation projection when the water container is in place. When the water container is filled and the water container is inverted and placed upon the upper rim. The valve is activated and water flows into the water reservoir portion and through the channel into the pet drinking portion, the water rising to a lower rim of the cap.

### FIELD OF INVENTION

This invention relates to the field of pet care and more specifically to an automatic pet watering device.

### BACKGROUND OF THE INVENTION

It is a daily chore for pet owners to provide clean drinking water for their pets. This usually requires filling a drinking bowl one or more times per day. If the bowl is filled to a level to provide water over a several hour period, there is usually enough water that the pet may cause some of it to spill out of the bowl and onto the floor. This can be a dangerous and possibly unsanitary condition. Various methods have been developed for automatically replenishing the water in a pet drinking bowl. Many of these methods have involved a water reservoir from which the bowl is refilled based upon the activation of a switch or lever operated by the pet. Such systems have often proven to be unreliable, causing the pet to go without water.

It is an objective of the present invention to provide a pet watering device that ensures that the pet will have access to a continual supply of fresh drinking water. It is a further objective to provide a device that minimizes the volume of water in a drinking reservoir at any one time to reduce the risk of contamination. It is a still further objective to provide pet watering device that controls spillage from the drinking reservoir. It is a still further objective of the invention to provide a device that is easily cleaned and refilled. Finally, it is an objective of the present invention to provide a pet watering device that is inexpensive to manufacture and easily packaged and shipped.

While some of the objectives of the present invention are disclosed in the prior art, none of the inventions found include all of the requirements identified.

### SUMMARY OF THE INVENTION

The present invention addresses all of the deficiencies of prior art pet watering device inventions and satisfies all of the objectives described above.

A pet watering device providing all of the desired features and functions incudes a base. The base has a pet drinking portion and a water reservoir portion. The pet drinking portion is connected to the water reservoir portion with a channel. The channel permits a lower inside surface of the pet drinking portion to be at a same height as a lower inside surface of the water reservoir portion. The water reservoir portion has a valve activation projection. The valve activation projection extends upwardly from the lower inside surface of the water reservoir portion and is located to align with a valve button.

A water container is provided. The water container is sized and shaped to fit above and rest upon an upper rim of the water reservoir portion. The water container has a reduced-size neck at a lower end. A cap is provided. The cap is sized and shaped to removably seal to the reduced-size neck. The cap encloses a valve. The valve controls a passageway between the water container and a lower opening in the cap. The valve is activated by the button located at a distal end. The button is located to bear against the valve activation projection when the water container is positioned upon the upper rim of the water reservoir portion.

When the cap is removed from the reduced-size neck, water is added to the water container, the cap is sealed to the water container, the water container is inverted and placed upon the upper rim, the valve activation projection will bear against the button, thereby activating the valve and permitting water to flow from the water container into the water reservoir portion. The water flows through the channel into the pet drinking portion, the water rising in the water reservoir portion and the pet drinking portion equally until the water reaches a level of a lower rim of the cap.

In a variant of the invention, a threaded connection is provided between the reduced-size neck and the cap.

In another variant, the valve is located within the passageway of the cap and includes a shaft, the shaft has the button at the distal end and a conical sealing member at a proximal end, the shaft fits slidably within a horizontal mounting fixture. A compression spring is located about the shaft between the button and the horizontal mounting fixture. The conical sealing member is sized and shaped to fit sealably against an upper edge of the passageway. The compression spring biases the conical sealing member against the upper edge of the passageway, thereby controlling a flow of water from the water container through the passageway and into the water reservoir portion.

In still another variant, the cap further includes at least one notch in the lower rim and a least one opening of a height equal to the at least one notch in a lower edge of the passageway. The notch and the opening permit water entering the water reservoir portion to rise to a level of a top of the at least one notch and the at least one opening.

In yet another variant, the at least one opening is radially offset from the at least one notch.

In a further variant, the at least one notch and the at least one opening have a shape selected from the group consisting of: rectangular, round, oval, triangular, and irregular.

In still a further variant, the water container further includes a sealably removable base. The sealably removable base permits easy cleaning of an interior of the water container.

In yet a further variant, a charcoal filter is provided. The charcoal filter is sized and shaped to fit removably in or adjacent the reduced-size neck.

In a final variant, the water container further includes an integral carrying handle.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention illustrating a channel between a pet drinking portion of the base and a water reservoir portion of the base;

FIG. 2 is a side cross-sectional view of the FIG. 1 embodiment illustrating the valve in the closed position;

FIG. 3 is a side cross-sectional view of the FIG. 1 embodiment illustrating the valve in the open position with a pet drinking portion and a water reservoir portion filled with water;

FIG. 4 is an enlarged side cross-sectional view of the cap and valve of the FIG. 1 embodiment illustrating the valve in a closed position;

FIG. 5 is an enlarged side cross-sectional view of the cap and valve of the FIG. 1 embodiment illustrating the valve in the closed position;

FIG. 6 is a perspective view of the cap and valve of the FIG. 1 embodiment as seen from the underside;

FIG. 7 is a perspective view of the base of the FIG. 1 embodiment and a second embodiment of a water container with a removable lid;

FIG. 8 is a second embodiment of a water container having a carbon water filter installed;

FIG. 9 is a perspective view of the FIG. 8 carbon water filter;

FIG. 10 is a side view of the cap of the FIG. 1 embodiment illustrating a rectangular notch in the cap;

FIG. 11 is a side view of the cap of the FIG. 1 embodiment illustrating a triangular notch in the cap; and

FIG. 12 is a side view of the cap of the FIG. 1 embodiment illustrating a pointed notch in the cap.

### DETAILED DESCRIPTION OF THE PREFERRED EMBODIMENT

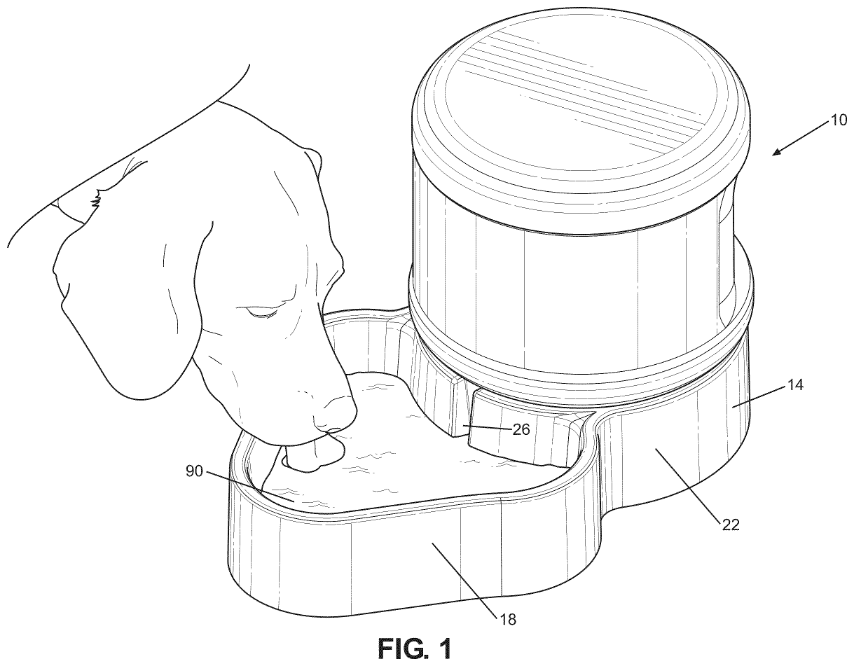

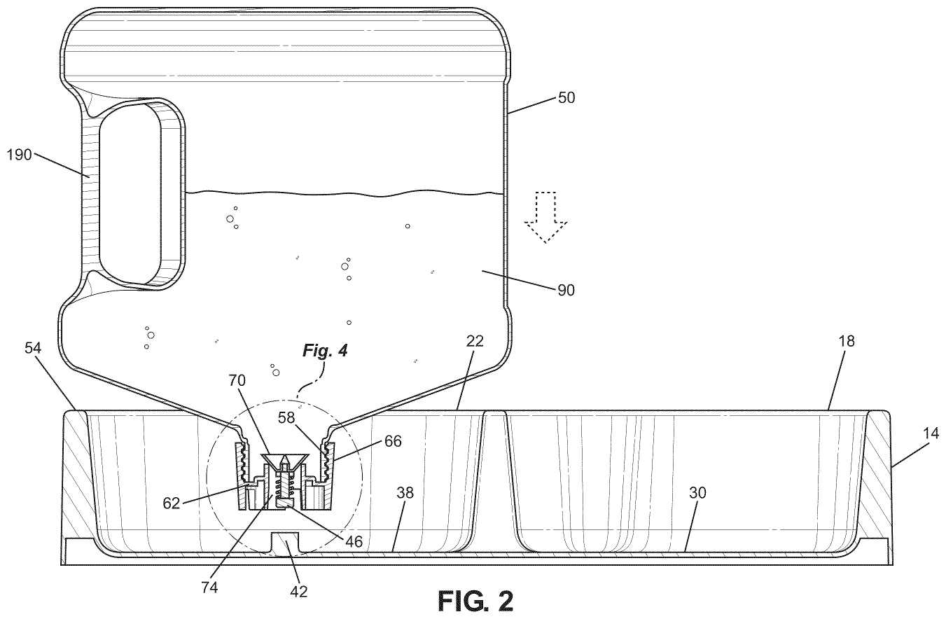

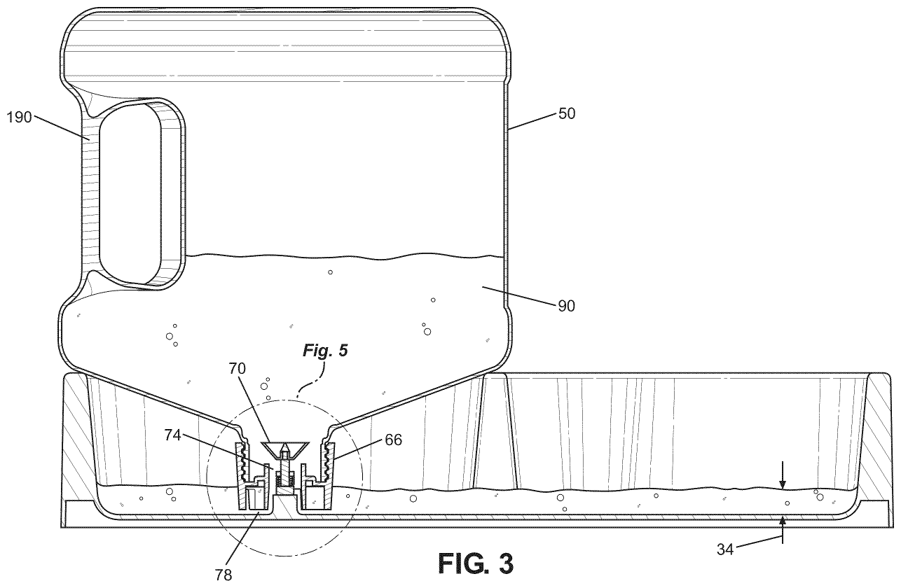

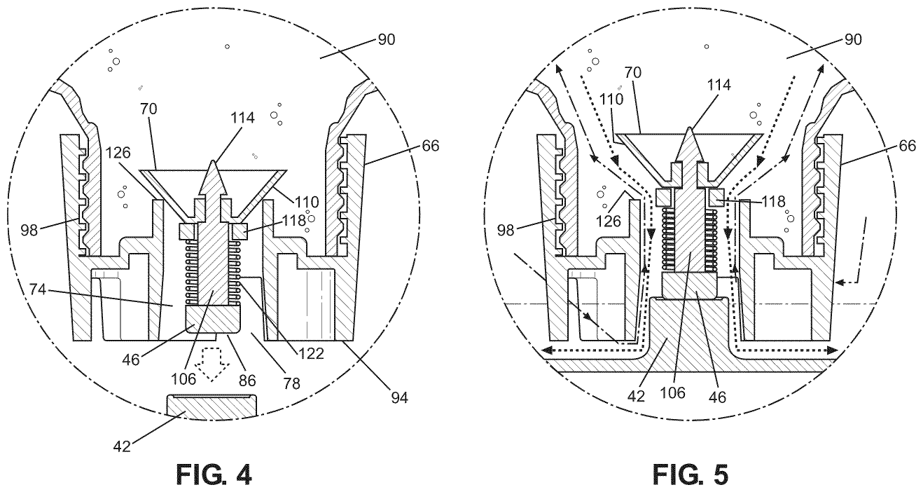

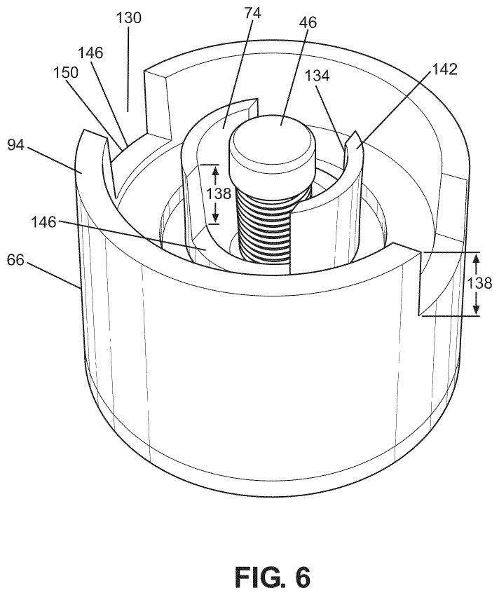

FIGS. 1-12 illustrate a pet watering device 10 providing all of the desired features and functions and incudes a base 14. As illustrated in B FIGS. 1-3, the base 14 has a pet drinking portion 18 and a water reservoir portion 22. The pet drinking portion 18 is connected to the water reservoir portion 22 with a channel 26. The channel 26 permits a lower inside surface 30 of the pet drinking portion 18 to be at a same height 34 as a lower inside surface 38 of the water reservoir portion 22. The water reservoir portion 22 has a valve activation projection 42. The valve activation projection 42 extends upwardly from the lower inside surface 38 of the water reservoir portion 22 and is located to align with a valve button 46.

A water container 50 is provided. The water container 50 is sized and shaped to fit above and rest upon an upper rim 54 of the water reservoir portion 22. The water container 50 has a reduced-size neck 58 at a lower end 62. A cap 66 is provided. The cap 66 is sized and shaped to removably seal to the reduced-size neck 58. The cap 66 encloses a valve 70. The valve 70 controls a passageway 74 between the water container 50 and a lower opening 78 in the cap 66. The valve 70 is activated by the button 46 located at a distal end 86. The button 46 is located to bear against the valve activation projection 42 when the water container 50 is position upon the upper rim 54 of the water reservoir portion 22.

When the cap 66 is removed from the reduced-size neck 58, water 90 is added to the water container 50, the cap 66 is sealed to the water container 50, the water container 50 is inverted and placed upon the upper rim 54, the valve activation projection 42 will bear against the button 46, thereby activating the valve 70 and permitting water 90 to flow from the water container 50 into the water reservoir portion 22. The water 90 flows through the channel 26 into the pet drinking portion 18, the water 90 rising in the water reservoir portion 22 and the pet drinking portion 18 equally until the water 90 reaches a level of a lower rim 94 of the cap 66.

In a variant of the invention, as illustrated in FIGS. 1-5, a threaded connection 98 is provided between the reduced-size neck 58 and the cap 66.

In another variant, the valve 70 is located within the passageway 74 of the cap 66 and includes a shaft 106, the shaft 106 has the button 46 at the distal end 86 and a conical sealing member 110 at a proximal end 114, the shaft 106 fits slidably within a horizontal mounting fixture 118. A compression spring 122 is located about the shaft 106 between the button 46 and the horizontal mounting fixture 118. The conical sealing member 110 is sized and shaped to fit sealably against an upper edge 126 of the passageway 74. The compression spring 122 biases the conical sealing member 110 against the upper edge 126 of the passageway 74, thereby controlling a flow of water 90 from the water container 50 through the passageway 74 and into the water reservoir portion 22.

In still another variant, as illustrated in FIGS. 1-6, the cap 66 further includes at least one notch 130 in the lower rim 94 and a least one opening 134 of a height 138 equal to the at least one notch 130 in a lower edge 142 of the passageway 74. The notch 130 and the opening 134 permit water 90 entering the water reservoir portion 22 to rise to a level 146 of a top 150 of the at least one notch 130 and the at least one opening 134.

In yet another variant, the at least one opening 134 is radially offset from the at least one notch 130.

In a further variant, as illustrated in FIGS. 10-12, the at least one notch 130 and the at least one opening 134 have a shape 154 selected from the group consisting of: rectangular 158, pent roof 162, oval (not shown), triangular 170, and irregular (not shown).

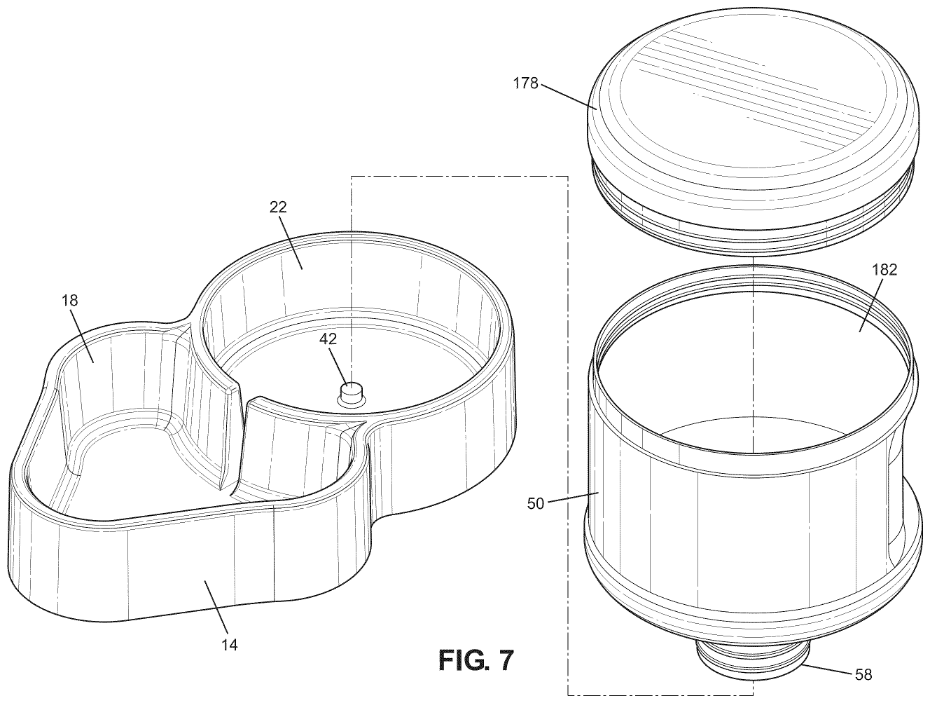

In still a further variant, as illustrated in FIG. 7, the water container 50 further includes a sealably removable base 178. The sealably removable base 178 permits easy cleaning of an interior 182 of the water container 50.

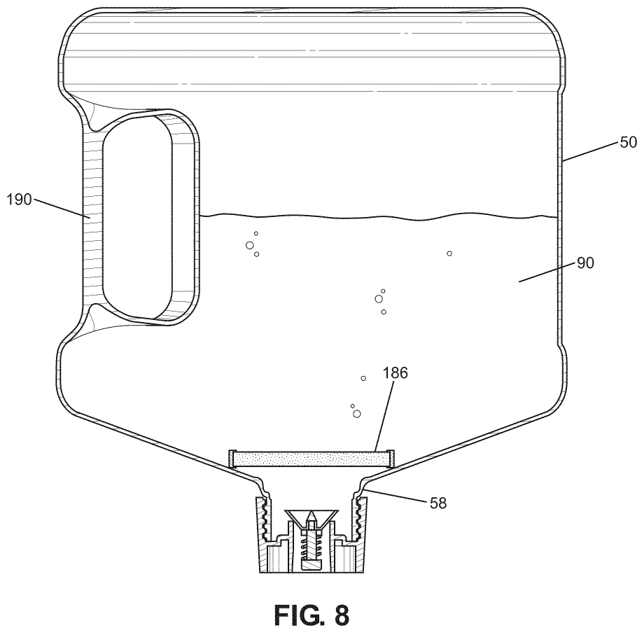

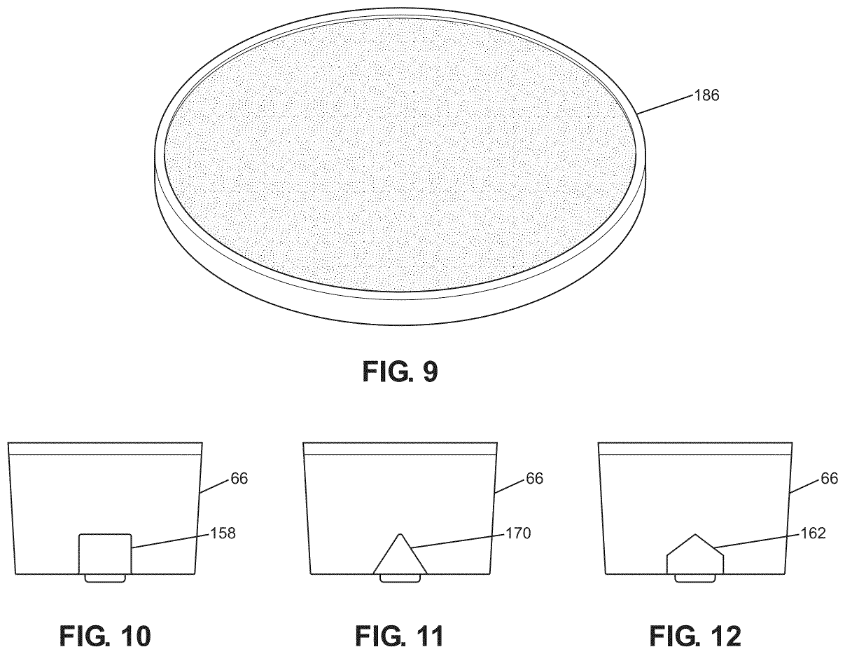

In yet a further variant, as illustrated in FIGS. 8 and 9, a charcoal filter 186 is provided. The charcoal filter 186 is sized and shaped to fit removably in or adjacent the reduced-size neck 58.

In a final variant, the water container 50 further includes an integral carrying handle 190.

1. A pet watering device, comprising:
a base, said base having a pet drinking portion and a water reservoir portion;
said pet drinking portion being connected to said water reservoir portion with a channel, said channel permitting a lower inside surface of said pet drinking portion to be at a same height as a lower inside surface of said water reservoir portion;
said water reservoir portion having a valve activation projection, said valve activation projection extending upwardly from said lower inside surface of said water reservoir portion and being disposed to align with a valve button;
a water container, said water container being sized and shaped to fit above and rest upon an upper rim of said water reservoir portion;
said water container having a reduced-size neck at a lower end;
a cap, said cap being sized and shape to removably seal to said reduced-size neck;
said cap enclosing a valve, said valve controlling a passageway between said water container and a lower opening in said cap;
said valve being activated by said button disposed at a distal end, said button being disposed to bear against said valve activation projection when said water container is position upon said upper rim of said water reservoir portion;
whereby, when said cap is removed from said reduced-size neck, water is added to said water container, said cap is sealed to said water container, said water container is inverted and placed upon said upper rim, said valve activation projection will bear against said button, thereby activating said valve and permitting water to flow from said water container into said water reservoir portion and through said channel into said pet drinking portion, said water rising in said water reservoir portion and said pet drinking portion equally until said water reaches a level of a lower rim of said cap.

2. A pet watering device, as described in claim 1, further comprising a threaded connection between said reduced-size neck and said cap.

3. A pet watering device, as described in claim 1, wherein said valve is disposed within said passageway of said cap, and comprises a shaft, said shaft having said button at said distal end and a conical sealing member at a proximal end, said shaft fitting slidably within a horizontal mounting fixture, a compression spring disposed about said shaft between said button and said horizontal mounting fixture, said conical sealing member being sized and shaped to fit sealably against an upper edge of said passageway, said compression spring biasing said conical sealing member against said upper edge of said passageway, thereby controlling a flow of water from said water container through said passageway and into said water reservoir portion.

4. A pet watering device, as described in claim 3, wherein said cap further comprises at least one notch in said lower rim and a least one opening of a height equal to said at least one notch in a lower edge of said central chamber, said notch and said opening permitting water entering said water reservoir portion to rise to a level of a top of said at least one notch and said at least one opening.

5. A pet watering device, as described in claim 4, wherein said at least one opening is radially offset from said at least one notch.

6. A pet watering device, as described in claim 4, wherein said at least one notch and said at least one opening have a shape selected from the group consisting of:
rectangular, round, oval, triangular, pent-roofed and irregular.

7. A pet watering device, as described in claim 1, wherein said water container further comprises a sealably removable base, said sealably removable base permitting easy cleaning of an interior of said water container.

8. A pet watering device, as described in claim 6, further comprising a charcoal filter, said charcoal filer being sized and shaped to fit removably in or adjacent said reduced-size neck.

9. A pet watering device, as described in claim 1, wherein said water container further comprises an integral carrying handle.
